(19) United States
(12) Patent Application Publication
(10) Pub. No.: US 2006/0204830 A1
(43) Pub. Date: Sep. 14, 2006

(54) Molten carbonate fuel cell

(75) Inventors: Stanford R. Ovshinsky, Bloomfield Hills, MI (US); Srinivasan Venkatesan, Southfield, MI (US); Dennis A. Corrigan, Troy, MI (US)

Correspondence Address: ENERGY CONVERSION DEVICES, INC., 2956 WATERVIEW DRIVE, ROCHESTER HILLS, MI, 48309, US

(73) Assignee: Ovonic Fuel Cell Company, LLC

(21) Appl. No.: 11/076,623

(22) Filed: Mar. 10, 2005

(51) Int. Cl. H01M 4/90; H01M 8/06; H01M 8/14

(52) U.S. Cl. 429/40; 429/19; 429/45

(57) ABSTRACT

A molten carbonate fuel cell with intrinsic energy storage. The molten carbonate fuel cell includes a hydrogen electrode utilizing a modified anode active material. The modified anode active material allows for intrinsic energy storage within the hydrogen electrode which provides for transient response, load leveling applications, a decreased start-up time, and ability to accept charge. The molten carbonate fuel cell may also include a modified cathode active material that allows for intrinsic energy storage within the oxygen electrode.

### FIELD OF THE INVENTION

The present invention generally relates to a molten carbonate fuel cell. More particularly, the present invention relates to a molten carbonate fuel cell using specialized anode active materials allowing for intrinsic energy storage.

### BACKGROUND

A fuel cell is an energy-conversion device that directly converts the energy of a supplied fuel into electrical energy. Researchers have been actively studying fuel cells to utilize the fuel cell's potential high energy-generation efficiency. The base unit of the fuel cell is a cell having an oxygen electrode, a hydrogen electrode, and an appropriate electrolyte. Fuel cells have many potential applications such as supplying power for transportation vehicles, replacing steam turbines, and power supply applications of all sorts. Despite their seeming simplicity, many problems have prevented the widespread usage of fuel cells.

Fuel cells, like batteries, operate by utilizing electrochemical reactions. Unlike a battery, in which chemical energy is stored within the cell, fuel cells generally are supplied with reactants from outside the cell. Barring failure of the electrodes, as long as the fuel, preferably hydrogen, and oxidant, typically air or oxygen, are supplied and the reaction products are removed, the cell continues to operate.

Fuel cells offer a number of important advantages over internal combustion engine or generator systems. These include relatively high efficiency, environmentally clean operation especially when utilizing hydrogen as a fuel, high reliability, few moving parts, and quiet operation. Fuel cells potentially are more efficient than other conventional power sources based upon the Carnot cycle.

The major components of a molten carbonate fuel cell are the hydrogen electrode for hydrogen oxidation and the oxygen electrode for oxygen reduction, both being in contact with an electrolyte. The electrolyte for molten carbonate fuel cells is typically molten lithium, sodium and/or potassium carbonates, soaked in a matrix. The reactants, such as hydrogen and oxygen, are fed through a porous hydrogen electrode and oxygen electrode and brought into surface contact and reacted with the electrolyte. The particular materials utilized for the hydrogen electrode and oxygen electrode are important since they must act as efficient catalysts for the reactions taking place.

In a molten carbonate fuel cell, the reaction at the hydrogen electrode occurs between hydrogen fuel and carbonate ions, which react to form carbon dioxide, water, and electrons. The overall reaction at the hydrogen electrode in the molten carbonate fuel cell is shown as:
H₂+(CO₃)⁻²−>CO₂+H₂O+2e⁻
At the oxygen electrode, oxygen, carbon dioxide, and electrons react in the presence of the oxygen electrode catalyst to reduce the oxygen and form carbonate ions. The reaction at the oxygen electrode in the molten carbonate fuel cell is shown as:
4e⁻+2CO₂+O₂−>2(CO₃)⁻²
The overall reaction for the molten carbonate fuel cell is shown as:
2H₂+O₂−>2H₂0
The flow of electrons from the hydrogen electrode to the oxygen electrode is utilized to provide electrical energy for a load externally connected to the hydrogen and oxygen electrodes.

Molten carbonate fuel cells require operation at temperatures of about 1,200° F. or 650° C. to achieve sufficient conductivity of the electrolyte. Despite higher temperature operation, molten carbonate fuel cells have certain advantages that make them attractive. Because of enhanced kinetics at the high operating temperatures, molten carbonate fuel cells may be directly fueled with hydrogen, carbon monoxide, natural gas, propane, landfill gas, marine diesel, and simulated coal gasification products. Carbon monoxide in coal derived fuel gas is readily shifted in situ to hydrogen and carbon dioxide under the forced conditions of the molten carbonate fuel cell. Because of high temperature operation, the anode kinetics of molten carbonate fuel cells are rapid thus not requiring noble metal catalysts for the cell's electrochemical oxidation and reduction processes. Molten carbonate fuel cells generally have high fuel-to-electricity efficiencies, of about 60% normally or 85% with cogeneration. Furthermore, molten carbonate fuel cells do not require any infrastructure development as they can be supplied with fuel from existing natural gas supply lines making their operation relatively inexpensive.

A main disadvantage of molten carbonate fuel cells is that the fuel cell requires several hours to reach operating temperatures and begin producing power. This start-up issue is inherent in all high temperature fuel cells. Another issue in molten carbonate fuel cells is the slow response to transients. Like other types of conventional fuel cells, the conventional molten carbonate fuel cell does not have intrinsic capability to store energy. Intrinsic energy storage allows for improvements in transient response, load leveling, and the ability to accept charge like a battery.

### SUMMARY OF THE INVENTION

To provide for intrinsic energy storage within molten carbonate fuel cells, the present invention provides for a hydrogen electrode having hydrogen storage capacity at temperatures greater than or equal to the operating temperature of said molten carbonate fuel cell. The molten carbonate fuel cell comprises a hydrogen electrode including a porous nickel sinter and a hydrogen storage material. The hydrogen storage material may be deposited onto the nickel sinter and/or deposited within the nickel sinter. The hydrogen storage material may be selected from one or more hydrogen storage materials having a melting point above the operating temperature of the molten carbonate fuel cell. The hydrogen storage materials are capable of absorbing and desorbing hydrogen at temperatures in the operating range of the molten carbonate fuel cell. The hydrogen storage material includes one or more hydrogen storage materials selected from magnesium hydrogen storage materials, transition metal hydrogen storage materials, and rare earth metal hydrogen storage materials. To achieve a melting point above the operating temperature of the molten carbonate fuel cell and/or to promote hydrogen absorption/desorption within the operating temperatures of the molten carbonate fuel cell, the hydrogen storage material may include one or more modifier elements. The hydrogen storage material may include one or more modifier elements selected from Fe, Ti, Ni, Mo, W, Ta, Co, Cr, Zr, V, Nb, C, B, Si, rare earth metals, and alkaline earth metals.

The molten carbonate fuel cell may further comprise an oxygen electrode having oxygen storage capacity at temperatures greater than or equal to the operating temperature of said molten carbonate fuel cell. The oxygen electrode may provide oxygen storage capacity via one or more redox couples which store oxygen via a change in valency state through oxidation/reduction reactions. The one or more redox couples have a melting point greater than the operating temperature of the molten carbonate fuel cell. The one or more redox couples may include a tin/tin oxide redox couple and/or a copper/copper oxide redox couple.

### BRIEF DESCRIPTION OF THE DRAWINGS

FIG. 1 shows a phase diagram for a binary Co—Y alloy.

FIG. 2 shows a phase diagram for a binary Ni—Y alloy.

FIG. 3 shows a schematic of a molten carbonate fuel cell in accordance with the present invention.

### DETAILED DESCRIPTION OF THE PREFERRED EMBODIMENTS OF THE INVENTION

Disclosed herein, is a molten carbonate fuel cell with intrinsic energy storage. The molten carbonate fuel cell is able to allow for transient response, load leveling applications, a decreased start-up time, and ability to accept charge like a battery. The molten carbonate fuel cell typically operates at an average temperature of 650° C., however the operating temperature may increase or decrease based on the type of electrolyte used therein.

The molten carbonate fuel cell generally comprises one or more cells connected in series. Each cell includes a hydrogen electrode, an oxygen electrode, and an appropriate electrolyte. The hydrogen electrode and the oxygen electrode are disposed adjacent to and separated by the electrolyte in each cell. The hydrogen and oxygen electrodes may be separated from the electrolyte by a metallic membrane which allows the flow of carbonate ions therethrough. The membrane acts to maintain the molten electrolyte positioned between the hydrogen electrode and oxygen electrode. The metallic membrane may be comprised of nickel, titanium, a nickel-titanium alloy, or titanium nitride. The cell also includes endplates positioned outside the hydrogen electrode and the oxygen electrode opposite the electrolyte.

The hydrogen electrode is generally comprised of a porous nickel sinter and a hydrogen storage material. By including a hydrogen storage material, the hydrogen electrode is able to store hydrogen thus allowing for intrinsic energy storage. The hydrogen storage material utilized in the hydrogen electrode, may also provide for a decreased start-up time for the molten carbonate fuel cell as the heat of hydride formation produced as a result of the absorption of hydrogen into the hydrogen storage material is able to assist in bringing the fuel cell up to operating temperatures.

The hydrogen storage material may be deposited on the surface and/or within the pores of the porous nickel sinter. The hydrogen storage material may be deposited onto the porous nickel sinter by a variety of techniques such as sputtering, pasting, chemical vapor deposition, plasma vapor deposition, spraying, dipping, etc. Where two or more hydrogen storage materials having differing hydrogen desorption temperatures are included in the electrode, the hydrogen storage materials may be layered throughout the electrode such that the hydrogen storage material having the lower hydrogen desorption temperature is closest to the molten electrolyte and the hydrogen storage material having the highest hydrogen desorption temperature is placed farthest from the solid impermeable electrolyte.

The porous nickel sinter may have a porosity of 55 to 70% with an average pore size of approximately 5 microns. The hydrogen electrode may have a thickness in the range of 0.5 to 0.8 mm. To prevent sintering of the hydrogen electrode during operation, certain conductive materials may be incorporated into the hydrogen electrode. Examples of conductive materials that may be incorporated into the hydrogen electrode to prevent sintering during operation at high temperatures are silicon carbide, titanium nitrides, tungsten oxides, and Ti₄O₇ (Ebonex).

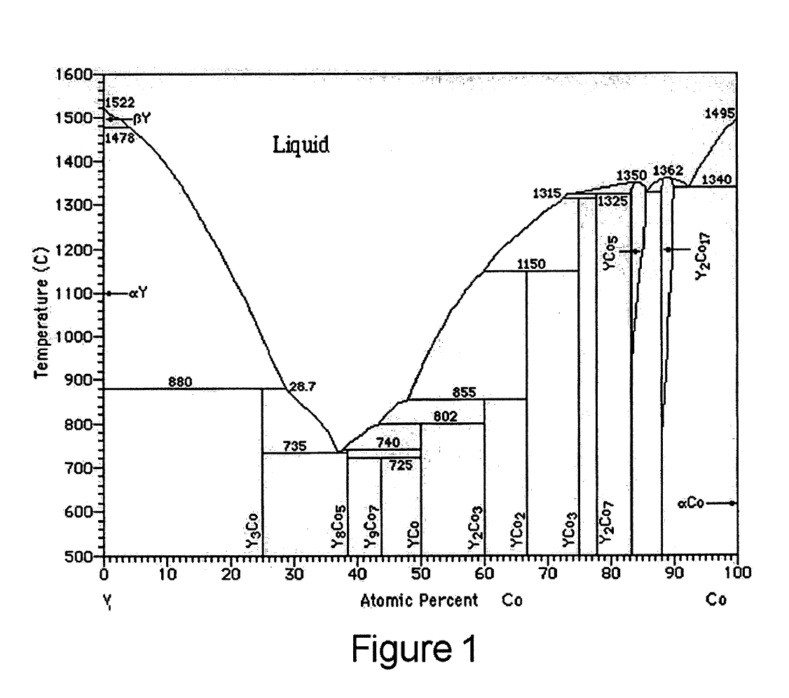

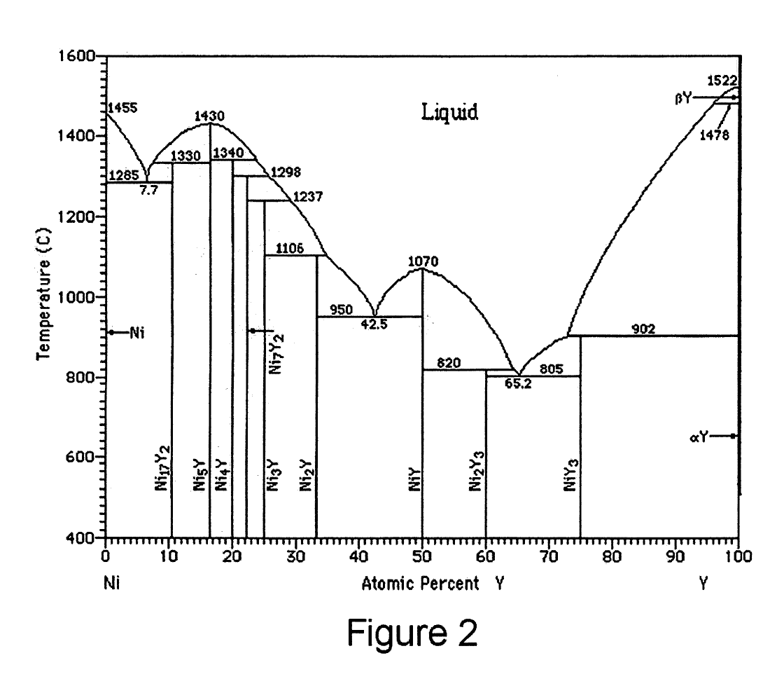

The hydrogen storage material may be selected from one or more hydrogen storage materials having a melting point above the operating temperature of the molten carbonate fuel cell. The hydrogen storage materials are capable of absorbing and desorbing hydrogen at temperatures in the operating range of the molten carbonate fuel cell. Conventional hydrogen storage materials having melting points below the operating temperature of the molten carbonate fuel cell are not suitable for providing intrinsic energy storage at temperatures greater than or equal to the operating temperature of the molten carbonate fuel cell. The hydrogen storage material may be selected from one or more hydrogen storage materials selected from magnesium hydrogen storage materials, transition metal hydrogen storage materials, and rare earth metal hydrogen storage materials. The hydrogen storage material may be represented by the AB, AB₂, A₂B₇, or A₂B families of hydrogen storage materials where component A is a transition metal, rare earth element having a high melting point, or combination thereof and component B is a transition metal element. Representative examples of component A include Ti, Zr, Co, Ce, Y, Pr, Ni, Nb, and combinations thereof. Representative examples of component B include Ni, V, Cr, Co, Mn, Y, and combinations thereof. Examples of binary transition metal hydrogen storage materials with hydrogen absorption/desorption properties are shown below in Table 1. Other examples of binary transition metal hydrogen storage materials that may be used in the hydrogen electrode are CO₆₀Y₄₀ and Y_{65.2}Ni_{34.8}. Shown in FIG. 1 is a phase diagram for a binary Co—Y alloy. Shown in FIG. 2 is a phase diagram for a binary Ni—Y alloy.

TABLE 1

| | Hydrogen storage | Heat of | Equilibrium | Desorption | Desorption Temperature |
|---|---|---|---|---|---|
| | capacity | formation | Pressure | Temperature | (° C.) at equilibrium |
| Composition | wt % max | (kJ/mol) | (bar) | (° C.) | pressure of 1 bar |
| ZrV₂ | 2.4 | 150 | | | 670 |
| ZrCo | 2 | | 1 | 430 | 430 |
| Ti₂Cu | 2.2 | 130 | 0.12 | 500 | 590 |

To further tailor the properties of the hydrogen storage materials for operation within the molten carbonate fuel cell, the base alloys may include one or more modifier elements selected from Fe, Ti, Ni, Mo, W, Ta, Co, Cr, Zr, V, Nb, C, B, Si, rare earth metals, and alkaline earth metals. The base alloys may also include catalytic metallic particles surrounded by a supporting matrix that has been engineered to improve access of electrochemically and thermally reactive species to catalytic sites, thereby improving kinetics.

The oxygen electrode as used in the molten carbonate fuel cell of the present invention may be generally comprised of a porous nickel oxide (NiO). The porous nickel oxide is generally formed by an in situ oxidation of a nickel sinter with atmospheric oxygen at, 600 to 650° C. while the electrode is in contact with the molten flux electrolytes. In situ oxidation of the nickel results in the automatic accumulation of 2-3 cation % lithium, which makes the cathode structure an electronically conducting ceramic having the formula LiₓNi₁₋ₓO, where x is in the range of 0.022 to 0.040. At 650° C. the resistivity of the material is 0.2Ω. The thickness of the cathodes has normally been maintained at about 0.3 mm. The cathodes may have a porosity of 55% to 70%, with an average pore size of approximately 10 microns.

The oxygen electrode may include one or more redox couples. Oxygen is stored in the oxygen electrode within the reversible redox couples, and is then available as needed, at the electrolyte interface of the oxygen electrode. The one or more redox couples are able to store and provide oxygen at the operating temperatures of the molten carbonate fuel cell. The one or more redox couples have a melting point greater than the operating temperature of the molten carbonate fuel cell. The oxidation/reduction reactions of the redox couples occur both thermodynamically and kinetically at temperatures greater than the operating temperature of the molten carbonate fuel cell. The redox couples provide the oxygen electrode with oxygen storage capacity at temperatures greater than or equal to the operating temperatures of the molten carbonate fuel cell while improving the efficiency of the fuel cell by matching the kinetics of the oxygen electrode to the kinetics of the hydrogen electrode. The oxygen stored in the redox couple may be utilized in the fuel cell during start-up or during operation when the flow of oxygen to the oxygen electrode is interrupted or if the molten carbonate fuel cell is used for transportation applications, regenerative braking energy could be recovered via oxygen storage in the redox couple.

Numerous redox couples exist and may be used to form the oxygen electrode of this invention. When such redox couples are used, cycling transition from the oxidized form to the reduced form is accomplished repeatedly and continuously. From a practical point of view, the ability to withstand repeated cycling is preferred.

While not wishing to be bound by theory, the inventors believe that the equations representing some of the many available redox reactions for the oxygen side of the fuel cell are presented below. Using a copper/copper oxide couple, the following is believed to be the useful fuel cell valency change mechanism:
O₂+4Cu −>2Cu₂O (Chemical Oxidation)
2Cu₂O+2CO₂+4e⁻−>2(CO₃)⁻²+4Cu (Electrochemical Reduction)
O₂+2CO₂+4e⁻−>2(CO₃)⁻² (Overall)
Using a tin/tin oxide couple, the following is believed to be the useful fuel cell valency change mechanism:
O₂+Sn−>SnO₂ (Chemical Oxidation)
SnO₂+2CO₂+4e⁻−>2(CO₃)⁻²+Sn (Electrochemical Reduction)
O₂+2CO₂+4e⁻−>2(CO₃)⁻² (Overall)
Redox couples as used in fuel cell oxygen electrodes are described in detail in U.S. Pat. No. 6,620,539 to Ovshinsky et al., published Sep. 16, 2003, the disclosure of which is hereby incorporated by reference.

The fuel cell oxygen electrodes of the instant invention may also include a catalytic material which promotes the dissociation of molecular oxygen into atomic oxygen (which reacts with the redox couple).

The oxygen electrodes may contain an active material component which is catalytic to the dissociation of molecular oxygen into atomic oxygen, catalytic to the formation of carbonate ions (CO₃⁻²) from carbon dioxide and oxygen ions, corrosion resistant to the electrolyte, and resistant to poisoning. A material useful as an active material in the oxygen electrode is a host matrix including at least one transition metal element which is structurally modified by the incorporation of at least one modifier element to enhance its catalytic properties. Such materials are disclosed in U.S. Pat. No. 4,430,391 ('391) to Ovshinsky, et al., published Feb. 7, 1984, the disclosure of which is hereby incorporated by reference. Such a catalytic body is based on a disordered non-equilibrium material designed to have a high density of catalytically active sites, resistance to poisoning and long operating life. Modifier elements, such as La, Al, K, Cs, Na, Li, Ga, C, and O structurally modify the local chemical environments of the host matrix including one or more transition elements such as Mn, Co and Ni to form the catalytic materials of the oxygen electrode. These low over-voltage, catalytic materials increase operating efficiencies of the fuel cells in which they are employed.

The electrolyte may be any electrolyte known in the art to be used for a molten carbonate fuel cell. Typically the electrolyte comprises one or more molten alkali metal carbonates. Examples of electrolytes utilized in molten carbonate fuel cells are molten mixtures of lithium, sodium and/or potassium carbonates which may be ternary lithium-potassium-sodium carbonates and binary lithium-potassium, lithium-sodium, or potassium-sodium carbonates. The carbonate electrolyte is solid at room temperatures and in liquid or molten form at operating temperatures in the range of 500° C. and 700° C. The electrolyte should provide for the transfer of carbonate ions (CO₃)⁻² therethrough while preventing the flow of other ions between the hydrogen electrode and the oxygen electrode. The electrolyte may also include one or more modifier elements which prevent segregation of the electrolyte during repeated use. The molten carbonates are retained in a matrix support structure positioned between and in contact with the electrolyte interfaces of the hydrogen electrode and the oxygen electrode. In addition to retaining the electrolyte and providing support to the cell, the matrix may be designed to prevent the fuel and oxidant gases from coming into contact within the cell. The electrolyte and matrix combination is often referred to as an electrolyte tile. The matrix may be comprised of submicron ceramic particles, such as lithium aluminate, which are compatible with the fuel cell environment.

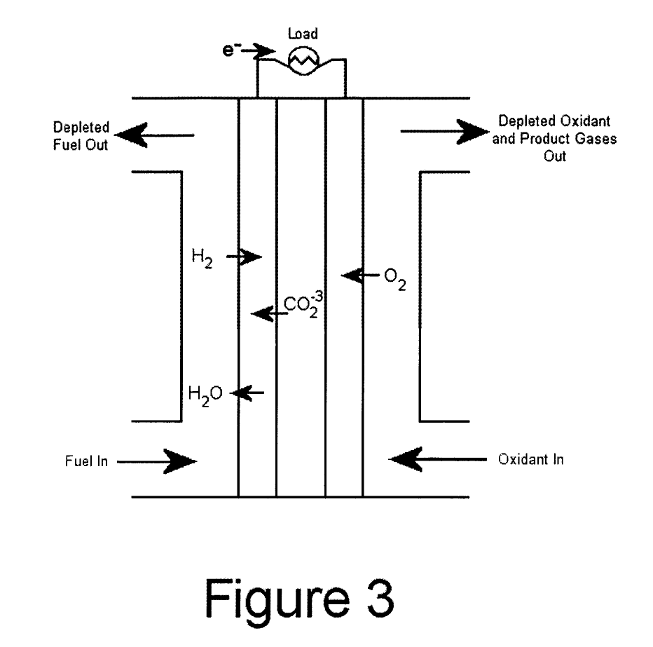

Shown in FIG. 3, is a schematic of a molten carbonate fuel cell in accordance with the present invention. The fuel supplied to the hydrogen electrode may be a hydrocarbon based fuel or a hydrogen containing stream. During operation, when a hydrocarbon based fuel is utilized as a fuel, the fuel enters the cell and contacts the fuel interface of the hydrogen electrode 11 and undergoes a reformation reaction producing hydrogen and carbon monoxide. The hydrogen produced by the reformation reaction passes through the hydrogen electrode 11 and/or is absorbed by the hydrogen electrode 11, and reacts with carbonate ions in the electrolyte 13 at the electrolyte interface of the hydrogen electrode to produce water and electrons. The carbon monoxide produced by the reformation reaction also passes through the hydrogen electrode and is reacted with carbonate ions to produce carbon dioxide which exits the cell via a fuel waste stream with any unused fuel and/or is supplied to the oxygen electrode. Water produced by the reduction reaction at the electrolyte interface of the hydrogen electrode 11 may be utilized in the reformation reaction to produce hydrogen, and/or may exit the cell with carbon dioxide and any unused fuel in the fuel waste stream.

When hydrogen is used as the fuel, no reformation of the fuel stream is needed. During operation, hydrogen enters the cell, passes through the hydrogen electrode 11 and/or is absorbed by the hydrogen electrode 11, and reacts with carbonate ions in the electrolyte 13 at the electrolyte interface of the hydrogen electrode 11 to produce water and electrons. Water vapor formed as a product of the reaction at the electrolyte interface exits the cell through a waste stream which may contain any unreacted hydrogen. When the fuel cell is shut down, hydrogen absorbed by the hydrogen electrode and stored in hydride form remains stored in the electrode. The stored hydrogen may then be consumed by the molten carbonate fuel cell upon startup to provide power prior to the fuel cell arriving at operating conditions necessary to reform the incoming fuel into hydrogen.

As fuel enters the cell and contacts the fuel interface of the hydrogen electrode, an oxidant stream containing oxygen and carbon dioxide is supplied to the cell and contacts the oxidant interface of the oxygen electrode 12. The oxidant stream passes through the oxygen electrode 12 and contacts the electrolyte 13 at the electrolyte interface of the oxygen electrode. Oxygen and carbon dioxide from the oxidant stream react with electrons produced at the electrolyte interface of the hydrogen electrode to form carbonate ions. The carbonate ions then pass through the electrolyte 13 and are reacted with hydrogen ions at the electrolyte interface of the hydrogen electrode. Unused oxygen, carbon dioxide and any other gases contained in the oxygen containing stream exit the cell via an oxidant waste stream.

The hydrogen electrode 11 and the oxygen electrode 12 are in electrical communication with each other via an external circuit. As electrons are produced at the hydrogen electrode by the reaction of hydrogen with carbonate ions, the electrons travel via the external circuit to the oxygen electrode where the electrons react with oxygen molecules and carbon dioxide molecules to form carbonate ions. The external circuit is in electrical communication with a load which utilizes the flow of electrons as a source of power.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A molten carbonate fuel cell comprising:
a hydrogen electrode including a porous nickel sinter and a hydrogen storage material having a hydrogen storage capacity at temperatures greater than or equal to the operating temperature of said molten carbonate fuel cell and a melting point greater than the operating temperature of said molten carbonate fuel cell.

2. The molten carbonate fuel cell according to claim 1, wherein said hydrogen storage material includes one or more hydrogen storage materials selected from transition metal hydrogen storage materials, magnesium hydrogen storage materials, and rare earth metal hydrogen storage materials.

3. The molten carbonate fuel cell according to claim 1, wherein said hydrogen storage material is represented by the AB, AB₂, A₂B₇, or A₂B families of hydrogen storage materials where component A is a transition metal, rare earth element or combination thereof and component B is a transition metal element.

4. The molten carbonate fuel cell according to claim 1, wherein said hydrogen storage material comprises one or more modifier elements selected from Fe, Ti, Ni, Mo, W, Ta, Co, Cr, Zr, V, Nb, C, B, Si, rare earth metals, and alkaline earth metals.

5. The molten carbonate fuel cell according to claim 1, wherein said hydrogen storage material is deposited on said nickel sinter.

6. The molten carbonate fuel cell according to claim 1, wherein said hydrogen storage material is deposited within said nickel sinter.

7. The molten carbonate fuel cell according to claim 1 further comprising an oxygen electrode having oxygen storage capacity.

8. The molten carbonate fuel cell according to claim 7, wherein said oxygen electrode has an oxygen storage capacity at temperatures greater than or equal to the operating temperature of said molten carbonate fuel cell.

9. The molten carbonate fuel cell according to claim 7, wherein said oxygen storage capacity is provided by one or more redox couples.

10. The molten carbonate fuel cell according to claim 7, wherein said one or more redox couples include a tin/tin oxide redox couple and/or a copper/copper oxide redox couple.

11. A hydrogen electrode for a molten carbonate fuel cell comprising:
a porous nickel sinter and a hydrogen storage material having a hydrogen storage capacity at temperatures greater than or equal to the operating temperature of said molten carbonate fuel cell and a melting point greater than the operating temperature of said molten carbonate fuel cell.

12. The hydrogen electrode according to claim 11, wherein said hydrogen storage material includes one or more hydrogen storage materials selected from magnesium hydrogen storage materials, transition metal hydrogen storage materials, and rare earth metal hydrogen storage materials.

13. The hydrogen electrode according to claim 11, wherein said hydrogen storage material is represented by the AB, AB₂, A₂B₇, or A₂B families of hydrogen storage materials where component A is a transition metal, rare earth element or combination thereof and component B is a transition metal element, Al, or combination thereof.

14. The hydrogen electrode according to claim 11, wherein said hydrogen storage material comprises include one or more modifier elements selected from Fe, Ti, Ni, Mo, W, Ta, Co, Cr, Zr, V, Nb, C, B, Si, rare earth metals, and alkaline earth metals.

15. The hydrogen electrode according to claim 11, wherein said hydrogen storage material is deposited on said nickel sinter.

16. The hydrogen electrode according to claim 11, wherein said hydrogen storage material is deposited within said nickel sinter.
